(19) United States
(12) Patent Application Publication
(10) Pub. No.: US 2009/0073981 A1
(43) Pub. Date: Mar. 19, 2009

(54) Methods and Apparatus for Network Packet Filtering

(75) Inventors: Alex Coyte, East Sydney (AU); Justin Viiret, Mount Osmond (AU); James Gregory, Mt Colah (AU)

Correspondence Address: MICHAEL MOLINS;MOLINS & CO., SUITE 5, LEVEL 6, 139 MACQUARIE ST, SYDNEY NSW, 2000, AU

(73) Assignee: Sensory Networks, Inc., Palo Alto, CA (US)

(21) Appl. No.: 12/209,206

(22) Filed: Sep. 12, 2008

Related U.S. Application Data
(60) Provisional application No. 60/973,176, filed on Sep. 18, 2007.

(51) Int. Cl. H04L 12/56

(52) U.S. Cl. 370/392

(57) ABSTRACT

Software and methods are disclosed for reducing the computational cost involved in network packet filtering The technology provides user level network packet filtering without incurring a context switch and minimizes the copying of data during packet filtering. The technology reduces or eliminates the need for expensive operating system data locks when performing network packet filtering.

### FIELD OF THE INVENTION

The present technology relates to network packet filtering.

### BACKGROUND OF THE INVENTION

High speed, or high throughput, network packet filtering (or “processing”) is a common network data security feature for a computer (“machine”) that is connected to a network, such as the internet. The filtering can be useful in, for example, intrusion detection systems, intrusion prevention systems, and unified threat management systems.

An existing method of filtering is the “ip_queue” network filtering module for Linux platforms. This method involves packet filtering at the user level. Data packets are delivered from an operating system kernel to a non-privileged user level application or process. The user level application analyses the data packets, and then informs the kernel whether the packets should be accepted (“re-injected”) or discarded (“dropped”). User level packet filtering therefore involves computationally expensive context switches (procedures required to store and restore the state of a processor).

Some existing network packet filtering processes place data packets into a queue. A user space packet processor may have to wait idly for the kernel to change the protection level for a data packet data and pass it into a queue. This waiting prevents the user space packet processor from pipelining the packet processing.

In existing network packet filtering systems, the processing of each packet requires operations to be performed in privileged and non-privileged contexts. These must be performed before any subsequent packet is processed. Therefore, a context switch is required for each packet, and the user space packet processor may only operate on a single packet before the operating system returns to a privileged context. The amount of work done per context switch is thus quite restricted. This restricts the overall throughput and efficiency of the packet processing system, while reducing the effective exploitation of multi-core (or “multi-CPU”) architectures.

### OBJECT AND SUMMARY OF THE INVENTION

It is an object of the present technology to reduce the computational cost involved in network packet filtering.

It is another object of the present technology to provide user level network packet filtering without incurring a context switch.

It is still another object of the present technology to enable independent scheduling for various aspects of user level data packet filtering.

It is a further objective of the present technology to minimize the copying of data during packet filtering.

It is a further object of the present technology to exploit the multi-processor architecture in a computer during user level network packet filtering.

It is a further object of the present technology to reduce or eliminate the need for expensive operating system data locks when performing network packet filtering.

It is a further object of the present technology to optimize the utilization of processor caches when performing network packet filtering on multi-processor architectures.

### DETAILED DESCRIPTION OF THE DRAWING FIGURES

In order the invention be better understood, reference is now made to the following drawing figures in which:

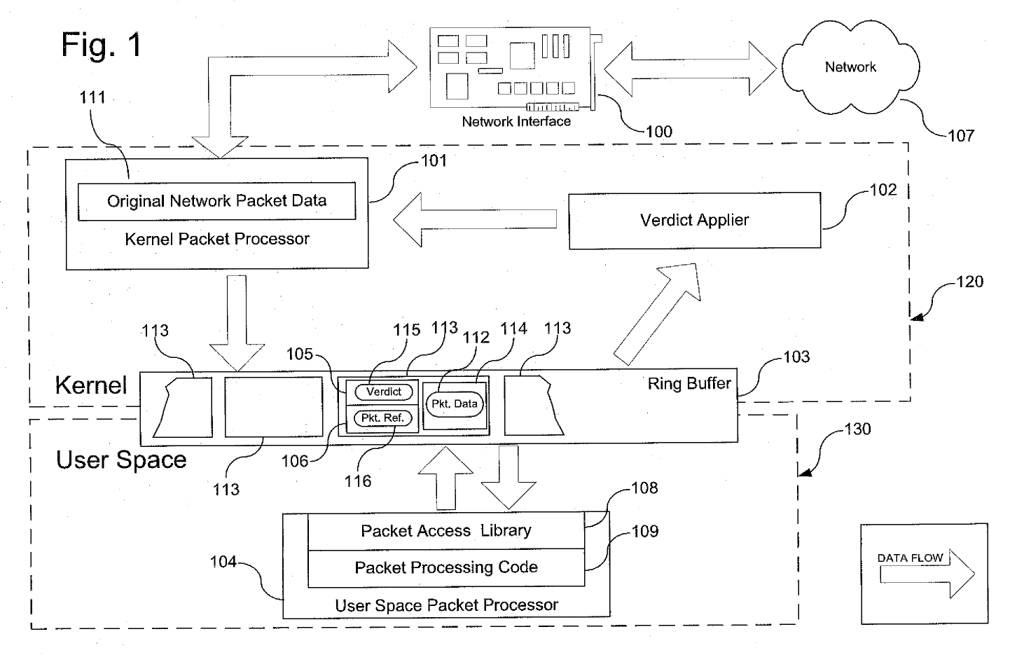

FIG. 1 is a schematic depicting an embodiment of the present technology, where one kernel packet processor and one user space packet processor are used;

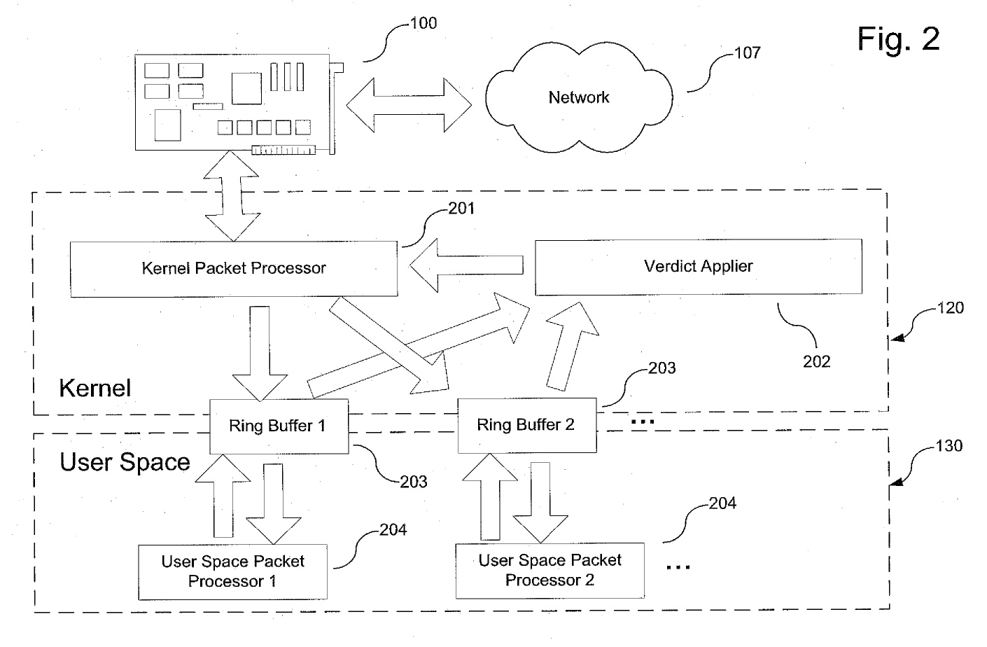

FIG. 2 is a schematic depicting an embodiment of the present technology, where multiple user space packet processors are used in conjunction with one kernel packet processor

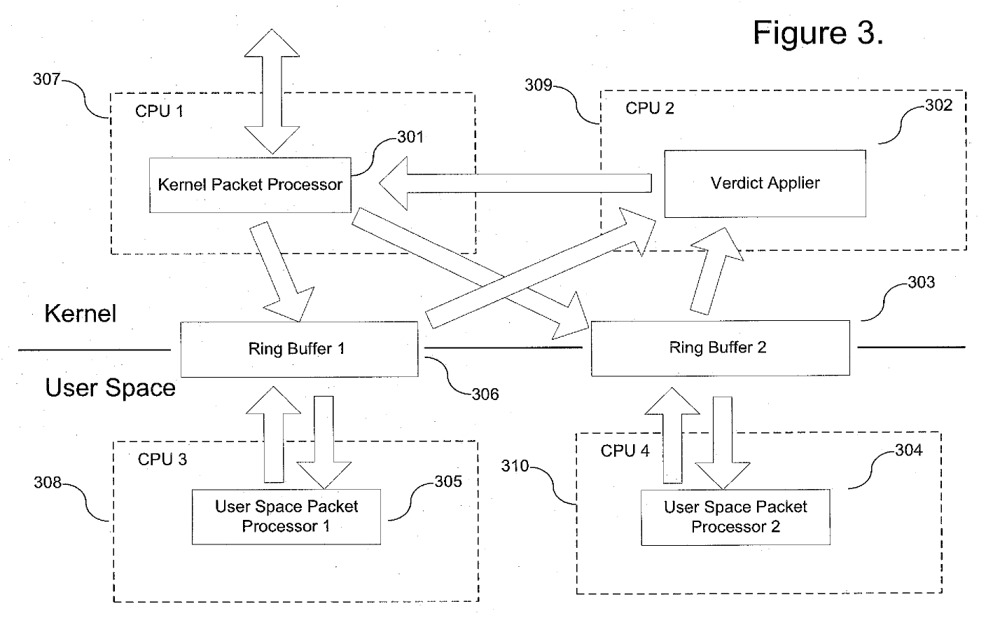

FIG. 3 is a schematic depicting an embodiment of the present technology, where the kernel and user space packet processors run on different CPUs;

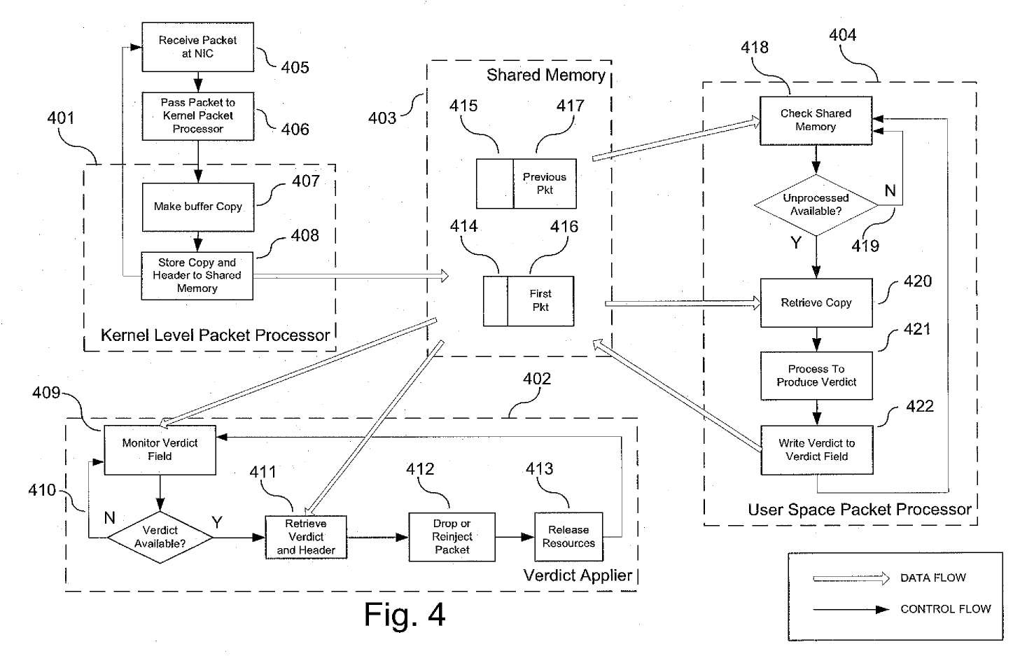

FIG. 4 is a flow-chart depicting an example of data handling in the present technology;

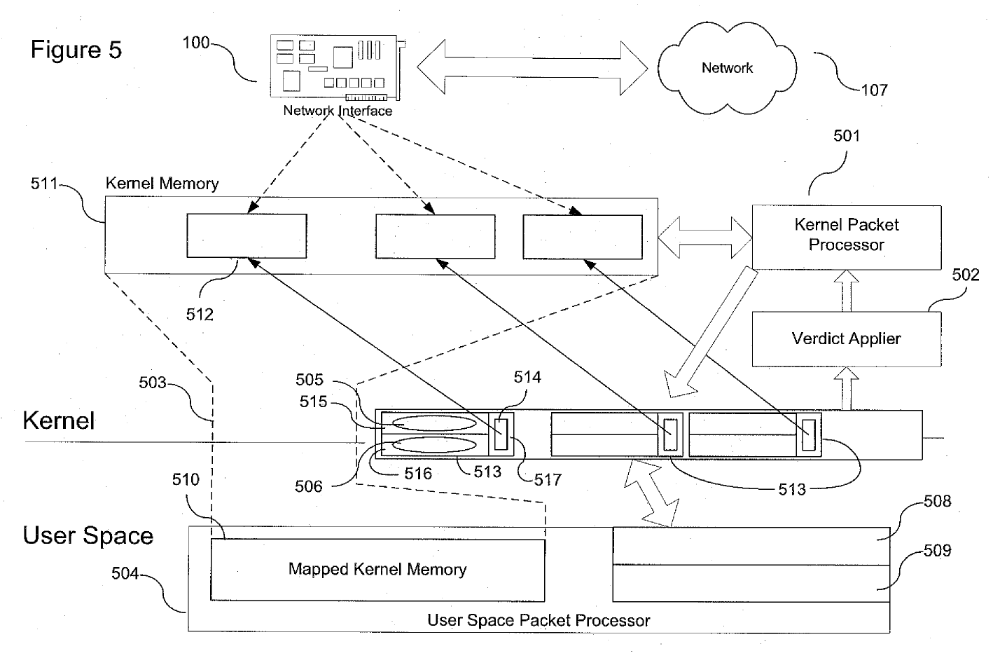

FIG. 5 is a schematic depicting an alternate embodiment of the present technology, where the kernel space processor does not copy the data packet; and

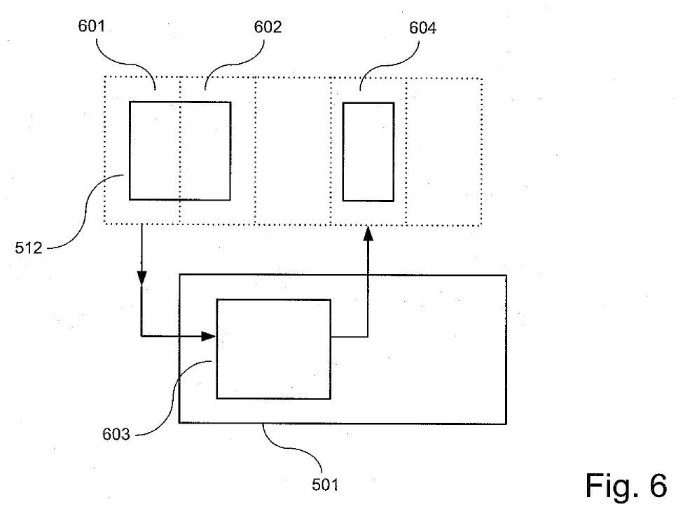

FIG. 6 is a schematic depicting a fallback mechanism; and

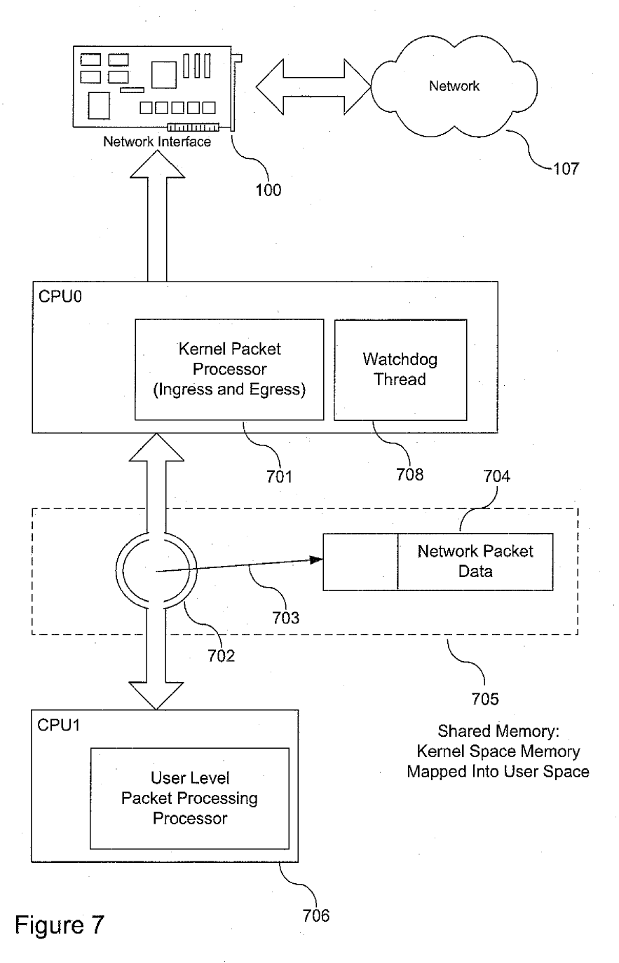

FIG. 7 is a schematic depicting and embodiment of the present technology, running on a 2-way multi-processor computer; and

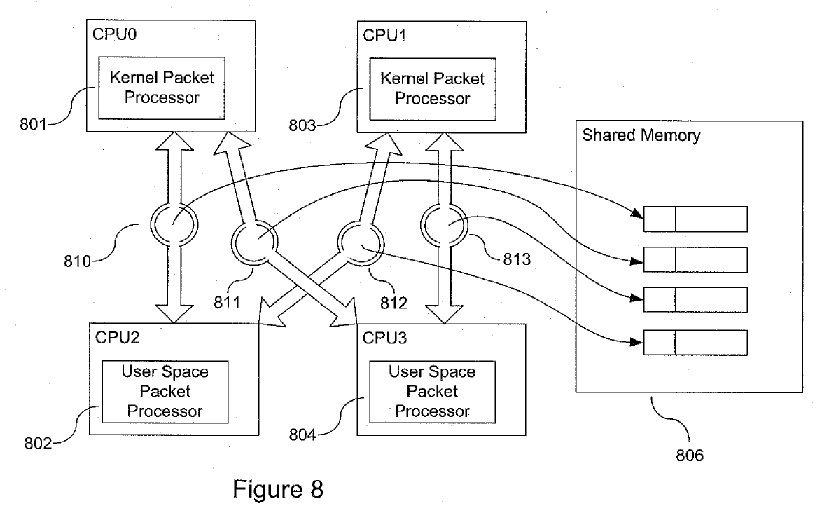

FIG. 8 is a schematic depicting and embodiment of the present technology, running on a 4-way multi-processor computer; and

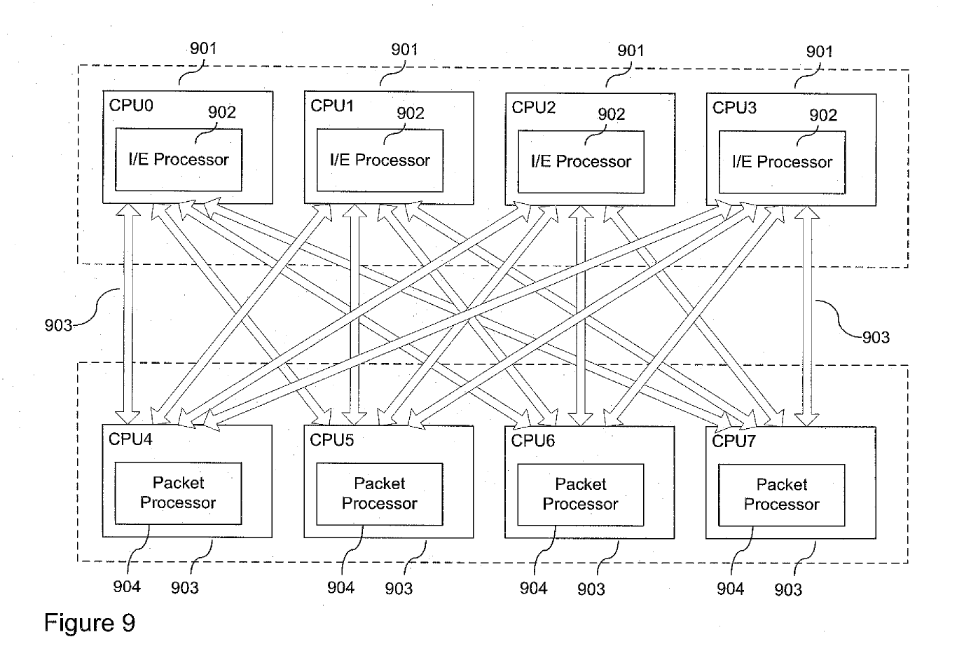

FIG. 9 is a schematic depicting and embodiment of the present technology, running on a 8-way multi-processor computer.

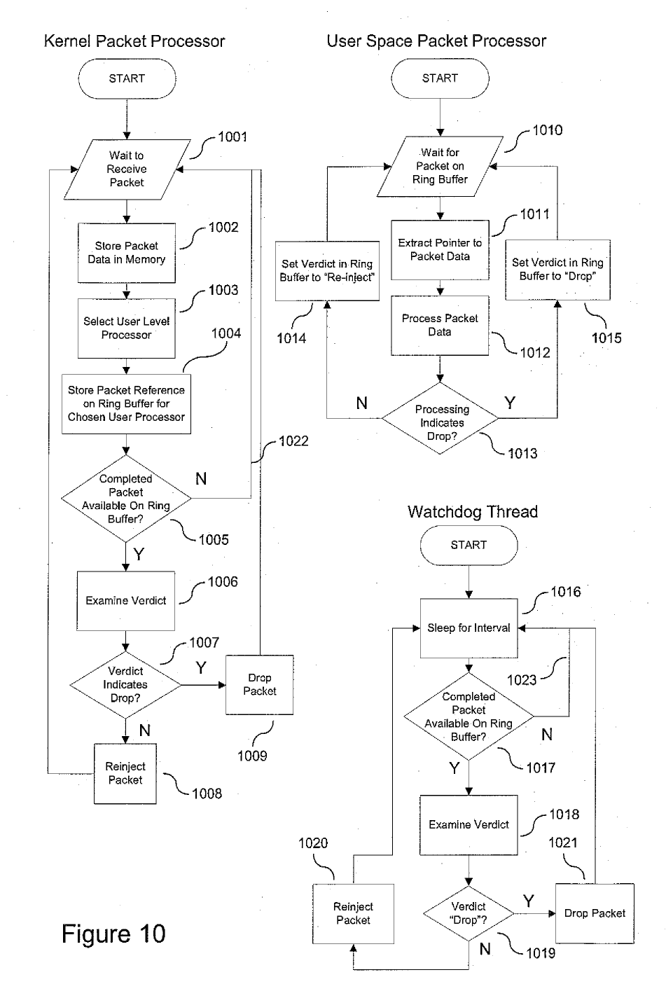

FIG. 10 is a collection of flow charts indicating the data handling processes of an embodiment of the current invention.

### BEST MODE AND OTHER EMBODIMENTS

Embodiment having One Kernel Packet Processor and One User Space Packet Processor The present technology includes a software and an apparatus for implementing user level packet filtering. The apparatus comprises a computer or machine having kernel module 120 and a user level library (or “user level module”) 130. The apparatus further comprises a lock-free memory data structure (or “shared memory”) 103 that is shared by the kernel module 120 and the user level module 130. In preferred embodiment, this shared structure 103 is a ring buffer.

The following paragraphs present a more detailed description of the kernel module 120, the shared memory 103, the user level module 130, and how these components interact and handle packet data.

The kernel module 120 comprises a kernel packet processor 101 and a verdict applier 102. The kernel packet processor 101 and verdict applier 102 can run in parallel to each other. The kernel module 120 contains a first code (or “verdict application code”) that is executed by the verdict applier 102. The kernel packet processor 101 may further contain standard codes that are executed during standard operation. In some embodiments, for example those designed for Linux platforms, the standard codes may be registered with the kernel packet processor 101 using one or more netfilter hooks. Therefore the standard codes may be executed as part of the standard network packet processing procedure. The verdict application code may be executed in parallel with the standard codes. In some embodiments, the verdict application code may be executed in a thread referred to as “kernel thread”. In other examples, another model of concurrent computing may be employed instead. One example is a Linux tasklet that may be used on a Linux platform.

A data packet from a network 107 is sent to the kernel packet processor 101 via a network interface card (NIC) 100. The kernel packet processor lo constructs a representation 114 of each original packet ill that is visible to the user space packet processor. In the preferred embodiment, this is done by duplicating the original packet 111 and inserting the copy (or “buffer copy”) 112, preferably along with some header information, into the shared memory 103. The duplication involves a “memory copy” operation. Unlike the “copy to user” operation used by the prior art, a memory copy operation is computationally inexpensive because it does not require the central computing unit (CPU) to change the protection level for the data packet. Some data packets are delivered in fragments over the network. The apparatus may further perform IP defragmentation on the original packets before their buffer copies are delivered to the shared memory.

The header information comprises a packet reference (or “packet identifier”) 116. The kernel packet processor 101 uses the unique packet reference 116 to identify the original packet to which the buffer copy 112 corresponds. In some embodiments, the packet reference 112 comprises a pointer for the memory address of the original packet 111. Some modern NICs provide accelerated transmission control protocol/internet protocol (TCP/IP) checksums for packets. The header information for a packet may further comprise the packet's checksum from the NIC. In these examples, the user space packet processor 104, as well as other user level applications such as firewalls or snorts, can directly leverage the checksum.

The shared memory 103 comprises a number of cells 113. Each cell 113 is dedicated to one network packet. To accommodate the aforementioned buffer copy 112 and its associated header information, each cell 113 further comprises three fields: a packet field 114, a reference field 106, and a verdict field (or “verdict place-holder”) 105. The packet field 114 holds the buffer copy 112. The reference field 106 holds the packet reference 116, and the verdict field 105 holds a “drop” or “accept” verdict 115 generated by the user level module 130. The data in all three fields are visible to the user level module 130.

The user level module 130 comprises a user space packet processor 104. The user space packet processor 104 further comprises a user level library (or “packet access library”) 108 and a user level packet processing code 109. The user space packet processor 104 executes codes contained in the user access library 108 to extract raw packet data from the packet field 114. The user level packet processing code 109 assesses the extracted packet data. Based on the assessment, the user level packet processing code 109 places a verdict 115 of either “accept” or “drop”, or their equivalents, into the verdict field 105.

The verdict applier 102 monitors the verdict field 105 for a verdict 115 that has been generated for a certain buffer copy 112. The verdict applier 102 discards or re-injects the original network packet data 111 depending on whether the verdict is “drop” or “accept”. The value of the verdict field (i.e. the verdict) 115, and the packet reference 116, provide all the information that is needed for the verdict applier 102 to accept or drop the original packet data 111.

Preferably, the verdict applier 102, the kernel packet processor 101, and the user space packet processor 104 are scheduled independently. This can be achieved, because the lock free shared memory allows a multi-threaded (or “pipe-lined”) approach. For example, the algorithm schedules the kernel packet processor 101 to receive a new original packet at the same time that a buffer copy of a previous original packet is scheduled to be processed by the user space packet processor. As another example, the algorithm schedules the kernel packet processor 101 to receive the new original packet at the same time the user space packet processor 104 is scheduled to place a verdict 115 for the previous packet's buffer copy. For example, the verdict applier 102 may be processing the verdict of a first packet while the User Space Packet Processor 104 is determining a verdict for a second packet. Simultaneously with either (or both) of these operations, the Kernel Packet Processor 101 may be enqueing a third network packet.

### Embodiments Having Multiple User Space Packet Processors

The more user space packet processors are provided, the more data packets can be simultaneously processed. Therefore, because of the aforementioned pipelining, the efficiency of data packet filtering is almost linearly enhanced with every addition of another user space packet processor 101. In a furthered preferred embodiment, the user space module comprises multiple user space packet processors.

As shown in FIG. 2, the user level module 130 and the kernel module 120 utilize a plurality of shared memories 203. The user space module incorporates a plurality of user space packet processors 204. The kernel packet processor 201 places buffer copies 112 of different original packets into different shared memories 203. Each user space packet processor 204 processes the data contained in a corresponding shared memory 203. The distribution of the buffer copies 112 may be done according to a predetermined distribution algorithm. For example, the distribution algorithm calculates a hash number based on the TCP/IP values of the data packet. The distribution algorithm decides which shared memory 203 should hold the copy, based on the hash number of the original data packet.

Some embodiments of the present technology can exploit computers that run on multi-CPU platforms As shown in FIG. 3, the kernel packet processor 301, the verdict applier 302, and the various user space packet processors 304,305, can further be executed by different CPUs 307, 308, 309, 310. A CPU (308, 310) responsible for the user space packet processing executes the processing code when, for example, the distribution algorithm distributes a new buffer copy to the CPU's corresponding shared data structure (306, 303). The use of different CPUs allows truly concurrent executions of different aspects of the data packet processing procedure.

### Example of Data Handling Process

FIG. 4 depicts an example of the data handling process in an embodiment having one user level data packet processor. A computer's network interface accepts 405 a first data packet from a network. The network interface passes 406 the first data packet to the kernel packet processor 401. The kernel packet processor makes 407 a first buffer copy 416 of this packet and places 408 the first buffer copy 416, along with the copy's associated header information 414, to the shared memory 403. Note that while the kernel processor processes the first data packet, the user space packet processor may be assessing the copy of another data packet.

The user space packet processor 404 monitors 418 the shared memory 403. It keeps monitoring 419 for a new buffer copy if the memory does not contain any not yet processed buffer copies. The user space packet processor retrieves 420 a not-yet processed buffer copy if one is available. The retrieved copy may be the first buffer copy 416, or it may be the buffer copy of a previous packet 417. In the event that there are more than one not-yet processed buffer copies, the user space packet processor retrieves the buffer copy on a first come first serve basis.

The user space packet processor 404 then executes the packet processing code to produce 421 a verdict. The verdict is placed 422 to the verdict field 414, 415 reserved for the retrieved copy 416, 417. The verdict applier 402 monitors 409 the verdict fields 416, 417 in the shared memory. It keeps monitoring 410 the memory if no new verdicts are present. The verdict detected by the applier may be the verdict 415 for a previous packet 417, or the verdict 414 for the first packet 416. The verdict applier retrieves 411 the detected verdict, as well as the verdict's associated header information 414, 415. The verdict applier then runs the verdict application code to drop or re-inject 412 the data packet for which the detected verdict is relevant 416, 417. Once a verdict has been successfully applied to the data packet that corresponds to the buffer copy, the verdict applier releases 413 the resources associated with the buffer copy so that said resources may be reused. Note that the various processes mentioned above may be performed concurrently. For example, the user space packet processor 404 can process a copy of a previous packet while the kernel packet processor 401 duplicates and extracts the header information of a new packet.

### 4. Minimization of Memory Copy Operation

FIG. 5 depicts a further embodiment of the current technology, where the kernel processor does not need to copy the data packet to a memory. This implementation may be utilized for single-core or multi-core computers. Referring to FIG. 5, the network interface card (NIC) 100 receives network packet data 512 over a communications network 107. Using Direct Memory Access (DMA), the NIC 500 distributes the packet to a kernel memory 511 that is accessible by a kernel packet processor 501.

In the previous embodiment, the kernel packet processor makes a copy of the packet data and stores it in a packet field within shared memory. In this embodiment, the kernel packet processor 501 stores a pointer 514 into the packet field 517. The pointer 514 “points to” the address in the kernel memory 511 at which the data packet 512 resides. Similar to the previous embodiments, each ring buffer cell 513 may have a verdict field 516 for storing a verdict 506, and a packet reference field 515 for storing a meta-data associated with the packet, such as a packet reference 505.

As in the previous embodiments, the user packet processor 504 comprises the aforementioned packet access library 508 and the packet processing code 509. In the current embodiment, the user space packet processor 504 further comprises a kernel space address map (or “mapped area”) 510. The kernel space address map 510 maps 503 kernel memory into the memory space of the user packet processor 504. All memory locations that may be used by the NIC 100 to store network packet data are included in the kernel space address map.

By executing a code contained in the packet access library 508, the user packet processor 504 extracts the pointer 514 Through the kernel space address map 503, the user packet processor 504 is able to directly access the network data 512 pointed to by the pointer 514. No copying or expensive operating system functions are required. Similar to the previous embodiments, an execution of the packet processing code 509 processes the packet data 512, produces a verdict 506, and places the verdict in the verdict field 516 in the ring buffer cell 513. The verdict applier 502, which monitors the ring buffer cells 513, applies the verdict whenever a new verdict is detected.

The current invention obviates the need for a memory copy operation to make data available to the user space packet processor 504. This improvement is facilitated by the kernel space address map 503. In the prior art, the user space packet processor has no mechanism for addressing or indexing the memory location containing the network packet data 512.

Referring to FIG. 6, a single network packet 512 may be broken across multiple physical memory pages 601, 602. Therefore, some embodiments may further comprise a fallback mechanism 603 that copies the packet 512 to a single memory page 604. The fallback mechanism 603 may be a code that resides in the kernel packet processor 501. The kernel packet processor 501 then stores a pointer that points to the single memory page 604 in the ring buffer cell 513. This prevents the requirement for address resolution between the kernel memory map and the user memory map.

### 5. Minimizing Concurrency Overhead and Removing Locking

FIG. 7 depicts a further embodiment of the invention in which there is no explicit verdict applier. In this embodiment, the functionality implemented by the verdict applier in previously described embodiments is incorporated into one or more kernel packet processors 701. In this embodiment, each kernel packet processor is responsible for both adding packet information to, and removing packet information from, one or more ring buffers 702; each ring buffer being used to pass packet information between a kernel packet processor and a user space packet processor.

In this embodiment, the kernel packet processor, on receipt of an incoming packet from the NIC 100, as in earlier described embodiments, stores the data of the incoming packet and some header information into an area of kernel memory 705 that is mapped into the address space of the one or more user space packet processors 706. The kernel packet process then stores, into the ring buffer 702, a pointer 703 to the address of the memory holding the network packet data 704. In this embodiment, the kernel packet processor then inspects one or more ring buffers, including the buffer to which data was just written, looking for one or more entries for which the verdict field has been set, indicating packets for which user level packet processing has completed. If such an entry is found, the kernel level packet processor discards, or re-injects the associated packet as determined by the value in the verdict field. This re-injection process is termed “egress processing”. By performing these inspection and re-injection operations, the kernel packet processor removes the need for a constantly running dedicated verdict applier thread.

In some embodiments, one or more “watchdog” threads 708 are periodically run to prevent the build up of unacceptable latency and “backing up” of the ring buffer structures. If the kernel packet processor is configured to perform egress processing on at most one packet for each packet for which it performs ingress processing, there is potential for user level processed packets to accumulate on one or more of the ring buffer structures. If user level processing of a first packet is not completed before the arrival of a second network packet on the ring buffer, that packet will not be available for the kernel level packet processor to perform egress processing. If a third network packet arrives after the completion of user level packet processing on the second packet, the ring buffer will contain two packets with set verdict fields. If the kernel packet processor is configured to perform egress processing on at most one packet, it is unable to empty the ring buffer. To alleviate this, the watchdog thread is executed periodically to perform egress processing on one or more packets that have built up on the ring buffers. This watchdog thread also prevents unacceptable latency in situations where the difference in the arrival times of two consecutive packets is longer than the acceptable latency. In this case, and for the case of the final packet processed by the system, the watchdog thread will be executed within an acceptable latency period and will perform egress processing of any waiting packets.

FIG. 7 depicts an embodiment in which only two physical processors are utilised, one for kernel packet processing and one for user space packet processing. In a multi-processor system with more than two processors, it is possible for more than one processor to be performing the tasks of the kernel packet processor and more than one processor to be performing the tasks of the user space packet processor. In such a system it is necessary to use some technique to prevent corruption of the ring buffer structures through access by multiple readers or writers. The ring buffer structures used in previously described embodiments are safe from corruption when access is restricted to a single reader and a single writer. Under such circumstances the data structure can be accessed without recourse to operating system locks or similar structures.

In a further embodiment of the invention, based on the previously described embodiment and operating on a multi-processor computer, one or more processors perform the tasks of the kernel packet processor, while one or more processors perform the tasks of the user space packet processor. FIG. 8 depicts such an embodiment in which there are two physical processors devoted to executing kernel packet processing and two physical processors devoted to user space packet processing.

Each kernel packet processor and user space packet processor instance is restricted to executing on a specific physical processor of the multi-processor computer. To avoid the requirement of using expensive (in processing overhead terms) concurrency control mechanisms, a single ring buffer structure is included for each pairing of a kernel level packet processor with a user space packet processor 810, 811, 812, 813. The inclusion of these ring buffer structures gives a dedicated communication channel between each pairing of a kernel packet processor and user space packet processor. Since these structures will only have one “writer”, the kernel level packet processor 801, 803, and one “reader”, the user space packet processor 802, 803 that examines the packet data and updates the verdict field in the ring buffer, the data structure is safe from concurrent access faults, without the need for any form of locking. In this embodiment of the invention, the communication channel (ring buffer) 810, 811, 812, 813 for each pairing of a kernel packet processor and user space packet processor is fixed. This architectural constraint combined with the allocation of both ingress and egress packet processing to the one or more kernel packet processors 801, 803, and the fact that kernel packet processing threads are tied to a specific physical processor causes egress processing for a given packet to be performed on the same physical processor as was used to perform ingress processing. This has the advantage of producing much more efficient use of the cache(s) associated with the physical processor(s). At least part of each network packet must be inspected during ingress and egress processing By ensuring that this processing occurs on the same physical processor, for any given packet, there is a high probability of the relevant data remaining in the processor cache over the duration of both ingress and egress processing. If the data is present in cache at the time of egress processing, the necessity of once again fetching that data from main memory is removed. This efficient utilization of the cache architecture can significantly increase the efficiency and throughput of the overall network filtering system.

FIG. 9 depicts the communication channels an embodiment of the invention running on an 8-way multiprocessor computer. Each kernel level ingress and egress packet processor 902 runs on a distinct CPU 901, and is connected via a communication channel 903 (ring buffer) to each user space packet processor 904 running on a separate physical processor 903. This gives a total of 16 ring buffers connecting the four kernel level processors 902 with the four user level processors 904.

### Example of Data Handling Process in Further Embodiment

FIG. 10 depicts an example of the data handling process in an embodiment described in the previous section, having one kernel level packet processor, one user space packet processor and a single “watchdog” thread.

The kernel level packet processing code (Kernel Packet Processor) and physical network interface wait 1001 for the arrival of an incoming network packet. On arrival of a packet, the packet data is stored 1002 into kernel memory. The kernel level code then selects 1003 a user level processor to perform packet inspection. The packet data is then stored 1004 by the kernel level code onto the appropriate ring buffer, determined by the choice of user level processor.

After storing packet data on a selected ring buffer, the kernel level code inspects 1005 the ring buffer for any packet data for which processing has completed. If no such data exists, the kernel level code returns 1022 to a state in which it is awaiting the arrival of another incoming packet. If processed data is available the kernel level code examines 1006, 1007 the verdict field of the header information on the ring buffer. If the verdict field indicates that the packet should be dropped, the kernel level code drops 1009 the packet. If the verdict field indicates that the packet should be re-injected, the kernel level code re-injects 1008 the packet.

The User Space Packet Processor waits 1010 for packet data to be inserted into the ring buffer. When data is found on the ring buffer, a pointer to the stored packet data is extracted 1011 from the ring buffer entry. This extracted pointer is used to directly access the data of the network packet to allow the user space code to process 1012 the packet data to determine whether the packet should be dropped or re-injected. If the processing indicates that the packet should be dropped 1013, the verdict field of the ring buffer structure is set to “drop” 1015. If the processing indicates that the packet should be re-injected 1013, the verdict field of the ring buffer structure is set to “re-inject” 1014.

The Watchdog Thread enters a “sleep” state during which it is inactive for a predetermined period of time 1016. When the Watchdog Thread awakes, it examines 1017 the ring buffer structure for any entries that indicate completed processing of the data for a given packet. If no such entry is available, the watchdog thread returns 1023 to the sleeping state. If an entry is available indicating completed processing the verdict field is examined 1018. If the verdict indicates 1019 that the packet should be dropped, the Watchdog Thread drops the packet 1021. If, however, the verdict indicates 1019 that the packet should be re-injected, the Watchdog Thread re-injects 1020 the packet

While the present invention has been disclosed with reference to particular examples and details of construction, these should be understood as having been provided by way of example and not as limitations to the scope or spirit of the invention.

1. A method for performing efficient network traffic filtering on a general purpose multi-processor computer, the method comprising repeatedly:
receiving a network packet data at a network device;
storing said packet data in memory;
storing reference information in a lock free data structure, the information being sufficient to facilitate examination of the data of the network packet;
extracting reference information from the lock free data structure;
examining the network packet data through use of the reference information;
determining if the network packet should be dropped or reinjected, based on examination of the network packet data;
dropping or re-injecting the network packet based on the result of examining the network packet data.

2. The method of claim 1 wherein:
the lock free data structure exists in a shared memory visible to privileged and non-privileged code;
the reference information is placed on the lock free data structure by a privileged code;
the reference information is extracted from the lock free data structure by a non-privileged code;
determination of whether to drop or re-inject the packet is performed by the non-privileged code;
the network packet is dropped or re-injected by privileged code.

3. The method of claim 1 wherein:
the reference information placed on the lock free data structure includes a verdict field that is set to indicate whether the packet should be dropped or re-injected;
the non-privileged code examines the network packet data and sets the verdict field to indicate if the packet should be dropped or re-injected;
the privileged code that drops or re-injects the packet does based on the value stored in the verdict field of the header information on the lock free data structure.

4. The method of claim 1 wherein:
the reference information includes a further copy of the network packet data, made by duplicating the network packet data after said data is stored.

5. The method of claim 2 wherein:
the network packet data is stored in memory visible to both privileged and non-privileged code;
the reference information includes a pointer to the memory into which the network packet data was placed;
the non-privileged “classification” code determines whether the network packet data should be dropped or re-injected by examining the network packet data via the pointer stored in the reference information.

6. The method of claim 5 wherein:
the network packet data is stored in memory by a conventional operating system network processing code;
the non-privileged code that determines whether the network packet should be dropped or re-injected maps into a local address space all memory that may be used by a conventional operating system network processing code to store the network packet data.

7. The method of claim 2 wherein:
a plurality of threads of execution exist in the privileged code;
a plurality of threads of execution exist in the non-privileged code;
the steps of storing a packet data, storing reference information on the lock free data structure, examining the packet data to determine whether to drop or re-inject the packet, and dropping or re-injecting the network packet are pipelined so that steps of the processing of different packets may simultaneously be performed by separate threads of execution.

8. The method of claim 2 wherein:
multiple lock free data structure instances are used for the storing of reference information for network packet data;
at least one lock free data structure instance exists for each paring of a privileged and non-privileged thread of execution;
each pairing of a privileged and non-privileged thread of execution is bound to a particular lock free data structure instance;
when processing a particular network packet data, a privileged thread of execution selects a particular non-privileged thread of execution to perform packet data examination, the privileged thread of execution then uses this selection to determine on which lock free data structure instance to store reference information for said network packet data.

9. The method of claim 8 wherein:
each privileged thread, after placing reference information for a particular network packet data on a selected lock free data structure, examines the contents of the lock free structure to determine if reference data exists on the lock free data structure for any network packet data for which examination by a non-privileged thread of execution has completed and, on finding such reference data, drops or re-injects the referenced network packet; and
an additional privileged thread of execution exists that is not associated with any particular non-privileged thread, and that is not part of any pairing bound to any particular lock free data structure, said thread of execution periodically examining all lock free data structure instances to determine if reference data exists on the lock free data structure for any network packet data for which examination by a non-privileged thread of execution has completed, and on finding such reference data, dropping or re-injecting the referenced network packet.

10. An apparatus for performing efficient network traffic filtering, the apparatus comprising:
a plurality of network interface devices;
a receiver that receives network packet data for a plurality of network packets;
a packet data recorder, coupled to the receiver, that stores network packet data, received by the receiver, into a storage memory;
a lock free data structure implemented in a storage memory;
a reference information recorder that stores, in said lock free data structure, reference information sufficient to facilitate examination of said network packet data;
a network packet data examiner that examines said network packet data through use of reference information stored in said lock free data structure;
a verdict determiner that, from the results of one or more examinations performed by said network packet data examiner, determines if a network packet should be dropped or re-injected;
a network packet egress processor that, based on the determination by said verdict determiner, drops said network packet or re-injects said network packet.

11. The apparatus of claim 10 wherein:
the receiver, packet data recorder, reference information recorder, network packet data examiner, verdict determiner and network packet egress processor is software in the memory of a general purpose computer.

12. The apparatus of claim 11 wherein:
said general purpose computer runs a multi-tasking operating system with privileged and non privileged levels of code execution.

13. The apparatus of claim 12 wherein:
said lock free data structure resides in memory accessible to both privileged and non-privileged code;
said receiver comprises privileged level code;
said reference information recorder comprises privileged level code;
said network packed data examiner comprises non-privileged level code;
said verdict determiner comprises non-privileged level code;
said packet egress processor comprises privileged level code.

14. The apparatus of claim 10 wherein:
said reference information contains a Boolean verdict field;
said verdict determiner writes a value to the verdict field based on the results of the inspection performed by the packet data examiner;
said packet egress processor decides to drop or re-inject the network packet based on examination of the verdict field.

15. The apparatus of claim 10 wherein:
said reference data contains a copy of the network packet data.

16. The apparatus of claim 11 wherein:
said packet data recorder stores network packed data in memory visible to both privileged and non privileged code;
the reference information includes a pointer to the memory into which the network packet data was stored;
said network packet data examiner examines said network packet data through use of said pointer stored in the reference information.

17. The apparatus of claim 11 wherein:
the packet data recorder comprises conventional operating system network code;
the packet data examiner uses conventional shared memory mapping to map into its address space all memory that may be used by the packed data recorder to store network packet data.

18. The apparatus of claim 11 wherein:
said packet data recorder, reference information recorder, network packet data examiner, verdict determiner and packet egress processor each comprise multiple threads of execution;
the operational steps of these threads of execution are pipelined so that individual steps of the processing of different network packets may be executed concurrently, where concurrent execution includes conventional operating system time-slice multi-programming and actual simultaneous execution on multiple processors of a multi-processor general purpose computer.

19. The apparatus of claim 18 wherein:
the apparatus incorporates multiple lock free data structures for the storage of reference information for network packet data;
at least one lock free data structure instance exists for each possible paring of a reference information recorder thread of execution with a network packet data examiner;
each possible paring of a reference information recorder thread of execution with a network packet data examiner thread of execution is associated with a particular lock free data structure instance;
when recording reference information for a particular network packet data, a reference information recorder thread of execution selects a particular packet data examiner thread of execution and subsequently stores reference information on the lock free data structure associated with the particular pairing of said reference information recorder thread of execution with the chosen packet data examiner thread of execution.

20. The apparatus of claim 19 wherein:
the operations of each reference information recorder thread of execution are integrated into a single thread of execution with the operations of a packet egress processor thread of execution, the apparatus incorporating a plurality of such combined threads of execution;
each such combined thread of execution, after placing reference information for a particular network packet data on a selected lock free data structure, examines the contents of the lock free structure to determine if reference data exists on the lock free data structure for any network packet data for which examination by a packet data examiner thread of execution has completed and, on finding such reference data “drops” or “re-injects” the corresponding network packet;
an additional privileged thread of execution exists that is not associated with any particular lock free data structure, said thread of execution periodically examining all lock free data structure instances to determine if reference data exists on the lock free data structure for any network packet data for which examination by a non-privileged thread of execution has completed, and on finding such reference data, performing the actions of a network packet egress processor on such reference data and the associated network packet data.

21. The apparatus of claim 20 wherein:
the operating system operating on the general purpose computer is the GNU/Linux operating system;
privileged threads of execution are kernel level threads of execution;
non-privileged threads of execution are user space threads of execution;
the packet data recorder incorporates conventional GNU/Linux kernel network processing code;
packet data examiner threads use conventional shared memory mapping to map into their respective address spaces all memory that may be used by the kernel network processing code to store network packet data.

22. The apparatus of claim 21 wherein:
the lock free data structures a conventional ring buffers, or some data structure derived from the conventional operation of the ring buffer data structure.

23. The apparatus of claim 22 wherein:
no operating system locks are taken during the processing of network packet data other than those required by the operation of the conventional operating system kernel code for the receiving and transmission of network packet data through one or more network interfaces;
only a single copy of the data of each network packet is made in the memory of the computer during the processing of said network packet.
